(19) United States
(12) Patent Application Publication
(10) Pub. No.: US 2006/0258535 A1
(43) Pub. Date: Nov. 16, 2006

(54) METHOD OF USING SODIUM CARBONATE PEROXYHYDRATE AS AN HERBICIDE

(75) Inventor: ROBERT A. LAROSE, MARLBOROUGH, CT (US)

Correspondence Address: ROBERT S. SMITH, 1131-0 TOLLAND TURNPIKE, SUITE 306, MANCHESTER, CT, 06040, US

(73) Assignee: BIOSAFE SYSTEMS L.L.C.,, GLASTONBURY, CT (US)

(21) Appl. No.: 10/908,517

(22) Filed: May 16, 2005

(51) Int. Cl. A01N 25/00; A01N 25/16; A01N 25/04

(52) U.S. Cl. 504/116.1; 504/363

(57) ABSTRACT

A method for nonselective killing of weeds which includes providing a quantity of sodium carbonate peroxyhydrate; providing a quantity of a surfactant; mixing the surfactant and the sodium carbonate peroxyhydrate with water; providing foaming apparatus for generating a foam; generating a foam from the mixture of surfactant and sodium carbonate peroxyhydrate; and applying the foam to plants to be killed. In some forms of the present invention the ratio of sodium carbonate peroxyhydrate to water is at least one half of 1 pound per gallon of water. In still other forms of the invention the ratio of sodium carbonate peroxyhydrate to water will be less than 3 pounds per gallon of water. In still other forms of the invention the ratio of sodium carbonate peroxyhydrate to water will be about 1 pound per gallon of water.

### FIELD OF THE INVENTION

The invention relates to herbicides and fungicides used in the agriculture and horticulture fields and particularly to a method of application of sodium carbonate peroxyhydrate.

### BACKGROUND OF THE INVENTION

Approximately 10% of all plant species are weeds, or a total of some 30,000-weed species. Of these, 1,800 cause serious economic losses in crop production, and about 300 species plague cultivated crops throughout the world. The U.S. has become home to 70% of the world's worst weeds.

U.S. farmers spent an estimated $5.61 billion annually for herbicides, plus another $1.1 billion in application costs in 1997. Herbicides, chemicals designed specifically to kill weeds, account for more than 58% of all pesticide sales in the U.S. Aspelin, A. L. and Grube, A. H.: 1999, Pesticide Industry Sales and Usage: 1996 and 1997 market estimates. United States Environmental Protection Agency.

Herbicides, or chemical weed killers, have largely replaced mechanical methods of weed control in countries where intensive and highly mechanized agriculture is practiced. Herbicides provide a more effective and economical means of weed control than cultivation, hoeing, and hand pulling. Together with fertilizers, other pesticides, and improved plant varieties, they have made an important contribution to the increased yields we now have and serve to combat rising costs and shortages of agricultural labor. The heavy use of herbicides is confined to North America, Western Europe, Japan, and Australia. Without the use of herbicides, it would have been impossible to mechanize fully the production of cotton, soybeans, sugar beets, all grains, potatoes, and corn.

Herbicides are also used extensively away from the farm, in areas such as industrial sites, roadsides, ditch banks, irrigation canals, fence lines, recreational areas, railroad embankments, and power line rights-of-way. Herbicides remove undesirable plants that might cause damage, present fire hazards, or impede work crews. They also reduce costs of labor for mowing.

Herbicides are classed as selective when they are used to kill weeds without harming the crop and as nonselective when the purpose is to kill all vegetation. Both selective and nonselective materials can be applied to weed foliage or to soil containing weed seeds and seedlings, depending on the mode of action. The term true selectivity refers to the capacity of an herbicide, when applied at the proper dosage and time, to be active only against certain species of plants but not against others. But selectivity can also be achieved by placement, as when a nonselective herbicide is applied in such a way that it reaches the weeds but not the crop.

Herbicide classification would be a simple matter if only the selective and nonselective categories existed. However, there are multiple classification schemes that may be based on selectivity, contact versus translocation, timing, area covered, and chemical classification. Herbicides are also classified as contact or translocated. Contact herbicides kill the plant parts to which the chemical is applied and are most effective against annuals, those weeds that germinate from seeds and grow to maturity each year. Complete coverage is essential in weed control with contact materials. Translocated herbicides are absorbed either by roots or above-ground parts of plants and are then circulated within the plant system to distant tissues. Translocated herbicides may be effective against all weed types; however, their greatest advantage is in the control of established perennials, those weeds that continue their growth from year to year. Uniform application is needed for the translocated materials, whereas complete coverage is not required.

Another method of classification is the timing of herbicide application with regard to the stage of crop or weed development. Timing depends on many factors, including the chemical classification of the material and its persistence, the crop and its tolerance to the herbicide, weed species, cultural practices, climate, and soil type and condition.

The three categories of timing are preplanting, preemergence, and post emergence. Preplanting applications for control of annual weeds are made to an area before the crop is planted, within a few days or weeks of planting. Preemergence applications are completed prior to emergence of the crop or weeds, depending on definition, after planting. Post emergence applications are made after the crop or weed emerges from the soil.

Herbicide application based on the area covered involves four categories: band, broadcast, spot treatments, and directed spraying. A band application treats a continuous strip, as along or in a crop row. Broadcast application covers the entire area, including the crop. Spot treatments are confined to small areas of weeds. Directed sprays are applied to selected weeds or to the soil to avoid contact with the crop.

Over-the-top-application is a recent technique whereby herbicides are applied over-the-top on the crop and weeds shortly after germination. The crops in these instances are naturally tolerant to the specific herbicide or have been genetically engineered to be tolerant of specific herbicides. Examples of these genetically engineered crops are new varieties of cotton, corn, soybeans, canola, rice, sugar beets, wheat and turf. The active ingredient of the herbicide is translocated to other plants and destroys the shoots, roots, rhizomes, and stolons of these other plants.

Traditional herbicides work on the principal of chemical toxicity; weeds are capable through genetic mutation of developing a resistance to the toxins that affect it. In the moss and algae world, where generations are produced in the spans of weeks, the problem of genetic resistance is common. Within a very short amount of time, many weeds that were formally susceptible to certain chemical compounds, may within the span of a few years be resistant, so that the chemical either does not produce a kill or the dosage must be increased to produce a kill.

This is why herbicide applicators must cycle their applications of different chemical compounds so as not to allow moss and algae, that the applicator is trying to control, to become accustom to any one chemical compound and ultimately to become immune to the chemical. This practice of chemical rotation is both times consuming and expensive, since the applicators must have at minimum three different chemical compounds for various types of moss and algae pests.

Most herbicides must be used and applied with extreme caution. The applicator must at all times wear special protective personal protection clothing. This includes the use of respirator and eye protection, as well as chemical impervious coveralls and gloves. Herbicides produce a toxic residue and are by nature long lasting and complex compounds, over a period of time, direct exposure to herbicides can lead to human health concerns and in some cases direct exposure to certain herbicides can lead to toxic shock and death.

Due to the very nature of the herbicide that is designed to leave behind a toxic residue on either plant surfaces or in the soil, environmental damage is a direct concern. With the increasing concern over the impact of groundwater by complex pesticide compounds that do not break down into innocuous substances. It has been documented that pesticide compounds have directly impacted groundwater aquifers across the country and become a direct threat to the environmental security.

In addition to concerns about groundwater impacts, herbicides have the capacity to impact non-target organisms within the environment that come into contact with the chemical compounds. These organisms include fish, birds, other non-pest moss and algae, and all forms of animal life. There have been hundreds of documented cases of herbicides such as DDT and others entering the food chain and impacting birds such as the American bald eagle, storks, rainbow trout and others.

Sodium carbonate peroxyhydrate is a granular chemical which is the active ingredient in certain algaecide and fungicide products. The end product containing this active ingredient acts as an oxidizing agent and thus kills the target algae and fungal pests. The product is used outdoors for treating ornamental plants, turf grasses, and terrestrial landscapes. It is used, as well, for treatments in commercial greenhouses, garden centers and plant nurseries, including their storage areas. Sodium carbonate peroxyhydrate is a granular substance made by combining sodium carbonate and hydrogen peroxide. The mode of action is: when water is present, the compound breaks down into hydrogen peroxide and sodium carbonate. The hydrogen peroxide oxidizes and thus kills the target pests. After contact, the hydrogen peroxide breaks down harmlessly into water and oxygen. Typical uses include ornamental plants, turf grasses, terrestrial landscapes, as well as commercial greenhouses, garden centers, nurseries and storage areas. There are no food uses.

Examples of pests on which this substance is effective include: algae; bryophytes such as mosses, liverworts, and pearlworts; slime mold and their spores. The prior art application method is typically includes applying the granular product with a lawn spreader or other application method that will ensure uniform coverage. For plants in small pots, spreading is done by hand. All applications must be made under wet conditions. For use on turf grasses, application is immediately followed by watering for 8-10 minutes by sprinkler irrigation to a depth of ⅛ to 1/10 of an inch.

The Environmental Protection Agency of the United States government has determined that tests with sodium carbonate peroxyhydrate show minimal to mild toxicity for oral and dermal exposure. Dermal irritation also occurred. There was severe irreversible eye damage. The substance is not considered a dermal sensitizer. Exposure to the general population would be minimal. Workers are required to wear appropriate protective equipment to protect themselves, especially their eyes, from exposure to this corrosive substance. The Environmental Protection Agency has also determined that when the pesticide is applied in accordance with directions on the label, no harm is expected to birds, other terrestrial animals, freshwater fish, or freshwater invertebrates. In the case of non-target plants, no harm is foreseen if the label directions are followed. These directions recommend testing the plants on a small area for damage before proceeding with widespread application, and preventing the soil from becoming too alkaline. Precautionary statements are present on the label to prevent exposure to non-target insects, including honey bees.

### SUMMARY OF THE INVENTION

It is an object of the invention is to provide a process for controlling a broad spectrum of weeds.

It is an object the present invention to provide an herbicide that will not be toxic to humans and animals when applied in accordance with predefined procedures.

It has now been found that these and other objects of the present invention may be achieved by a method for nonselective killing of weeds which includes providing a quantity of sodium carbonate peroxyhydrate; providing a quantity of a surfactant; mixing the surfactant and the sodium carbonate peroxyhydrate with water; providing foaming apparatus for generating a foam; generating a foam from the mixture of surfactant and sodium carbonate peroxyhydrate; and applying the foam to plants to be killed.

In some forms of the present invention the ratio of sodium carbonate peroxyhydrate to water is at least one half of 1 pound per gallon of water. In still other forms of the invention the ratio of sodium carbonate peroxyhydrate to water will be less than 3 pounds per gallon of water. In still other forms of the invention the ratio of sodium carbonate peroxyhydrate to water will be about 1 pound per gallon of water.

The method may be used to kill weeds from the group consisting of liverwort, pearl wort, thistle and blue mustard. In other forms of the invention, the method may be used to kill weeds selected from the group consisting of algae, moss, liverwort, slime mold and slime mold spores.

The step of providing foaming apparatus may include providing foaming apparatus that utilizes pressurized air to generate foam and the surfactant may be a nonionic surfactant. The surfactant may be selected from the group consisting of X-77 (UAP), Induce (Helena), Activator 90 (UAP), Triton Ag 98 (Rhone-Poulenc) and R-11 (Wilfarm).

### DETAILED DESCRIPTION OF PREFERRED EMBODIMENTS

One aspect of the present invention includes a process for controlling a broad spectrum of weeds through the use of sodium carbonate peroxyhydrate applied as foam, through the use of a foaming apparatus. When sodium carbonate peroxyhydrate, which is also referred to herein as well as in the industry, as sodium percarbonate or PCS) foam material is applied to plant tissue it acts as a non-selective, contact herbicide for both pre emergent and post emergent applications.

Sodium carbonate peroxyhydrate is a non-hazardous granular product developed as an alternative to perborate bleaches in household detergents. When dissolved into water, its releases H₂O₂ and soda ash (sodium carbonate).
2Na₂CO₃.3H₂O₂--->2Na₂CO₃+3H₂O₂

The pH of the resulting solution is typically alkaline, which activates the H₂O₂ for bleaching. The dry powder contains about 30% by weight w/w H₂O₂ and finds specialty use as a wood brightener and general cleaning aid. Sodium carbonate peroxyhydrate is a strong oxidizing agent and when it is applied to plant material in a 1% spray solution it will react with simple celled plant material and kill on contact most forms of algae, bacteria, fungi, viruses and bryophyte plant material such as mosses, liverworts, hornworts, lichens.

When sodium carbonate peroxyhydrate is diluted in water and applied as a spray solution over the tops of growing plant material, the effect on most types of plant material, the phytotoxicity effects are minimal with some plant cell necrosis but often most plants survive spray solutions approaching the theoretical limit of the ability of the granular sodium carbonate peroxyhydrate to go into solution.

When sodium carbonate peroxyhydrate is diluted in water to a 1% solution (0.5 pounds to 2(½−1) pounds of sodium carbonate peroxyhydrate per gallon of water) and a nonionic surfactant is added to the solution to act as a foaming agent as well as to improve wetting and penetration of the active ingredient. The sodium carbonate peroxyhydrate/surfactant solution is applied to plant material as a foam, by means of a foam generator that combines air with the sodium carbonate peroxyhydrate/surfactant solution to produce a thick and viscous foam material. When this foam material is applied to living plant tissue, it reacts with the cell structure of plant cell walls causing phytotoxicity within 24-48 hours of the first application. The herbicidal action is due to the positive ion, which is reduced by photosynthesis to form a relatively stable free radical. This free radical is easily oxidized in the presence of oxygen to reform the original ion and hydrogen peroxide, which destroys the plant tissue. At the cellular level they cause cell and chloroplast membranes to rupture.

In accordance with a preferred embodiment of the method of the present invention, a sodium percarbonate formulation is used in combination with various combinations of foaming surfactants. The most familiar of all surfactants is soap, a simple substance which, in water, clearly demonstrates two effects. It produces foam due to its action at the air-water interface, and it makes the grease transfer from dirty hands into the soapy water as a result of its activity at the water-oil (grease) interface.

Many plants produce significant quantities of saponins (steroid or triterpenoid glycosides) which have surfactant properties. One such plant is the soapwort Saponaria officianalis whose foliage yields a glycoside capable of wetting, foaming and grease dispersion—the very qualities that we recognize in a modern detergent. It is likely that the saponins provided our ancestors with our first useful surfactants. These natural glycosides are still in use today for specialized processes such as washing delicate fabrics.

Surfactants (surface active agents) can be broadly defined as compounds which, when dissolved in water, concentrate at surfaces (interfaces) such as water-air or water-oil. The interfacial activity of these substances, which can be explained in terms of their molecular structure, gives rise to a wide range of surface chemistry functions: wetting, emulsifying, solubilizing, foaming/defoaming, rheology-modifying, antistatic, ‘glossing’, lubricity and surface conditioning.

Nonionic surfactants are the most prevalent form of surfactant used with herbicides. Most nonionic surfactants are composed of linear or nonyl-phenol alcohols or fatty acids. The function of surfactants in this class is to reduce surface tension, improve leaf surface spreading and sticking, and improve herbicide absorption. Examples of nonionic surfactants that are preferred in some embodiments of the present invention include: X-77 (UAP), Induce (Helena), Activator 90 (UAP), Triton Ag 98 (Rhone-Poulenc) and R-11 (Wilfarm).

This combination of sodium carbonate peroxyhydrate and one or more surfactants are combined in a chemical mixing tank and extracted into a mixing chamber and the chemical mixture is combined with compressed air to expand and aspirate the surfactant. Alternatively, any type of foaming generator may be used to achieve the same end result. The resulting aspirated chemical/surfactant mixture is extracted through a nozzle that produces a thick, chemically infused foam. The chemically infused foam containing the sodium carbonate peroxyhydrate solution when applied to living plant tissues, causes severe phyto-toxicity within the outer plant cell walls, essentially burning the plant, causing plant cell death. Typically, enough foliar plant damage occurs from contact with the sodium carbonate peroxyhydrate foam solution; then the weed stops living and dies. The sodium carbonate peroxyhydrate/foam treatment produces a number of resulting actions on living plant tissue. The sodium carbonate peroxyhydrate composition has a very high sodium level that exceeds the survival limits of most plant species, causing severe sodium toxicity. The foaming agent itself penetrates the sodium carbonate peroxyhydrate directly thought the pores of the plant tissue causing sodium toxicity. A secondary reaction of the sodium carbonate peroxyhydrate foam treatment is a direct oxidizing.

### EXAMPLE 1

### Liverwort Marchantia polymorpha

Liverwort (Marchantia polymorpha) is one of the most difficult to control weeds in nursery production. Liverwort thrives in low light, high humidity, high nutrition, and moist substrates. Liverwort is primitive plants that lack a vascular system. They are more closely related to ferns and mosses than more common seed-bearing plants. Liverwort spread sexually by spores and asexually by splashing gemmae. Spores are microscopic and airborne, and thus are impossible to exclude from propagation areas. Gemmae are small asexually produced clonal fragments that accumulate in specialized structures on liverwort thalli (leaves) called gemmae cups. Gemmae allow liverwort colonies to spread quickly from a single plant.

Liver wort was controlled when rates of ½ pound to 1 pound of Sodium Carbonate Peroxyhydrate was mixed per gallon of water and combined with one fluid ounce of foaming agent. The chemically infused foam was then applied to the liverwort weed growing on nursery stock containers. Liverwort is a noxious weed that belongs to the bryophyte family and is difficult to control. The foam was applied to the soil surface containing the weed and the weed was controlled within 48 hours of the sodium carbonate peroxyhydrate foam being applied. Subsequent observation indicated that there was no regrowth for up to one month later.

### EXAMPLE 2

### Pearlwort Sagina procumbens

Pearlwort is a very small matted perennial that occurs in cool moist climates. It is a grass-like plant that becomes particularly troublesome on golf greens and other closely mowed areas. Pearlwort generally creeps from a matted rosette and forms similar rosettes along its creeping branches. Leaves are very narrow, pointed and mostly opposite each other. Flowers are tiny and inconspicuous with four small petals and four longer sepals. They are generally found on long stems near the tips of the branches. Although pearlwort is one of the smallest weeds in turf, it can also be one of the most troublesome.

Pearl wort was controlled when rates of ½ lb to 1 pound of sodium carbonate peroxyhydrate chemical was mixed per gallon of water and combined with one fluid ounce of foaming agent. The chemically infused foam was then applied to the liverwort weed growing on nursery stock containers. Pearl wort is a noxious weed that belongs to the bryophyte family and is difficult to control. The foam was applied to the soil surface containing the weed and the weed was controlled within 48 hours of the sodium carbonate peroxyhydrate foam being applied. Subsequent observation indicated that there was no re-growth for up to one month later.

### EXAMPLE 3

### Thistle: Cirsium arvense

Thistle is a creeping perennial and it is considered to be a noxious weed, which is difficult to eradicate because of its extensive root system. When, mowed in a lawn, it will not develop full height and flower. Thistle is invasive due to shoots from its root system. Pulling generally is not effective due to the tremendous reserves in the root system, and new shoots appear soon after pulling. Regular, persistent pulling may gradually starve the root system. Thistle was controlled after two applications were applied to the foliar portion of the plant.

The first application was made using rates of ½ lb 1 pound of sodium carbonate peroxyhydrate chemical was mixed per gallon of water and combined with one fluid ounce of foaming agent. The chemically infused foam was then applied to the thistle plant the foam was applied to the entire plant surface containing and the thistles foliar portion showed sever necrosis of the plant tissue within 48 hours of foam application over 65% of the thistle surface. A second application of the sodium carbonate peroxyhydrate/foam was made within 48 hours of the first application. Upon completion of the second application, there was a 95% foliar damage to all plant cells of the thistle plant and there was no regrowth of the plants for the rest of the growing season.

### EXAMPLE 4

### Blue Mustard: Chorispora tenella

Blue mustard is a winter annual that germinates in the fall and produces a rosette with deeply lobed leaves, similar in appearance to a dandelion. Blue mustard bears purple or blue flowers at the top of the plant in March through April. Leaves on the flowering stems are coarsely toothed and have wavy margins.

Blue Mustard was controlled when rates of ½ pound to 1 pound of sodium carbonate peroxyhydrate chemical was mixed per gallon of water and combined with one fluid ounce of foaming agent. The chemically infused foam was then applied to the Blue Mustard weed growing on nursery stock containers. The foam was applied to the soil surface containing the weed and the weed was controlled within 48 hours of the sodium carbonate peroxyhydrate foam being applied. Subsequent observation indicated that there was no re-growth within the next month.

Thus, the testing has established that the foamed application of sodium carbonate peroxyhydrate has greater efficacy than methods that utilize a dry application of chemicals followed by watering or a sprayed solution is applied to the plants to be killed.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for nonselective killing of weeds which comprises:
providing a quantity of sodium carbonate peroxyhydrate;
providing a quantity of a surfactant;
mixing the surfactant and the sodium carbonate peroxyhydrate with water;
providing foaming apparatus for generating a foam;
generating a foam from the mixture of surfactant and sodium carbonate peroxyhydrate; and
applying the foam to plants to be killed.

2. The method as described in claim 1 wherein the ratio of sodium carbonate peroxyhydrate to water is at least one half of 1 pound per gallon of water.

3. The method as described in claim 1 wherein the ratio of sodium carbonate peroxyhydrate to water is about 1 pound of sodium carbonate peroxyhydrate to 1 gallon of water.

4. The method as described in claim 1 wherein the weeds to be killed are selected from the group consisting of liverwort, pearl wort, thistle and blue mustard.

5. The method as described in claim 1 wherein the ratio of sodium carbonate peroxyhydrate to water is less than 3 pounds of sodium carbonate peroxyhydrate to 1 gallon of water.

6. The method as described in claim 1 wherein the plans to be killed are selected from the group that includes algae, moss, liverwort, slime mold and slime mold spores.

7. The method as described in claim 1 wherein the step of providing foaming apparatus includes providing foaming apparatus that utilizes pressurized air to generate foam.

8. The method as described in claim 1 wherein the step of providing a surfactant includes providing a nonionic surfactant.

9. The method as described in claim one wherein the step of providing a surfactant includes providing a surfactant selected from the group consisting of X-77 (UAP), Induce (Helena), Activator 90 (UAP), Triton Ag 98 (Rhone-Poulenc) and R-11 (Wilfarm).
